(19) United States
(12) Patent Application Publication
(10) Pub. No.: US 2009/0268327 A1
(43) Pub. Date: Oct. 29, 2009

(54) CHARACTERISTICS EVALUATING METHOD AND CHARACTERISTICS EVALUATING APPARATUS FOR A MAGNETIC HEAD

(75) Inventor: Shigeru Akema, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/334,132

(22) Filed: Dec. 12, 2008

(30) Foreign Application Priority Data
Apr. 28, 2008 (JP) 2008-117360

(51) Int. Cl. G11B 27/36

(52) U.S. Cl. 360/31

(57) ABSTRACT

A rotating support mechanism that rotates and supports the head slider between a position where the magnetic field generated by a magnetic field generating apparatus and a hard bias magnetic field of the head slider are antiparallel and a position where an air-bearing surface (ABS) of the head slider is perpendicular to the magnetic field; an external magnetic field applying unit for applying a static magnetic field to the head slider using the magnetic field generating apparatus at the position where the magnetic field generated by the magnetic field generating apparatus and the hard bias magnetic field of the head slider are antiparallel; and a unit for applying an alternating magnetic field onto the head slider using the magnetic field generating apparatus and carrying out measurement of ρH at the position where the ABS of the head slider is perpendicular to the magnetic field generated by the magnetic field generating apparatus.

### BACKGROUND OF THE INVENTION

1. Field of the Invention

The present invention relates to a characteristics evaluating method and a characteristics evaluating apparatus for a magnetic head that evaluate the durability of the magnetic head with respect to external magnetic fields and/or the magnetic characteristics with respect to the environmental temperature of the magnetic head.

2. Related Art

The routine way to evaluate the characteristics of a magnetic head is to apply an alternating magnetic field to the magnetic head and obtain a ρH curve. One method of evaluating the durability of a magnetic head with respect to external magnetic fields according to a ρH test applies a static magnetic field to the magnetic head from the outside and then carries out the ρH test. When the strength of the static magnetic field applied to the magnetic head from outside is increased, a point where the ρH curve becomes discontinuous will appear for a given static magnetic field. Accordingly, from the strength of the static magnetic field at which the ρH curve changes, it is possible to evaluate the stability of the magnetic head with respect to external magnetic fields.

The stability of output of a magnetic head with respect to environmental temperature is also evaluated by carrying out ρH tests while changing the environmental temperature of the magnetic head and evaluating whether the ρH curve is stable.

FIG. 6 shows an example of an apparatus that applies a magnetic field to a test element 5 to test the characteristics of the test element 5. In this example, coils 6 that apply an offset magnetic field are disposed at positions on both sides of the test element 5 and coils 7 that apply an alternating magnetic field in a direction that differs to the direction of the coils 6 by 90° are also disposed. The coils 6 that apply the offset magnetic field adjust the bias magnetic field that acts upon the test element 5, and by causing an alternating magnetic field to act upon the test element 5 from the air-bearing surface side while applying the bias magnetic field, the electromagnetic conversion characteristics of the test element 5 are evaluated.

### Patent Document 1

Japanese Laid-Open Patent Publication No. H10-283614

### Patent Document 2

Japanese Laid-Open Patent Publication No. 2002-312912

### Patent Document 3

Japanese Laid-Open Patent Publication No. 2005-158195

### SUMMARY OF THE INVENTION

When evaluating the durability of a magnetic head to external magnetic fields, a static magnetic field is applied as an external magnetic field to the magnetic head, an alternating magnetic field is applied perpendicularly to the air-bearing surface of the head slider, and measurements of ρH are carried out. In this case, as shown in FIG. 6, with a method where the coils that apply the static magnetic field and the coils that apply the alternating magnetic field for the measurement of ρH are disposed 90° apart, it is not possible to measure the ρH accurately.

Although the supplying of current to the coils 6 is stopped during measurements of the ρH curve, it is necessary to carry out measurement while monitoring whether a residual field is not produced in the coils 6, which makes the operation complex.

Also, since an arrangement where coils that generate a static magnetic field and coils that generate an alternating magnetic field is used, the apparatus construction is complex.

When cooling a head slider to evaluate the characteristics that accompany changes in the environmental temperature of the magnetic head, a Peltier element that can accurately control an arbitrary temperature is normally used. However, when a Peltier element is used, it is necessary to effectively remove the heat emitted from the element, with this being achieved by water cooling or air cooling. However, with either method, it is necessary to occupy a large space relative to the small size of the head slider, and to position such construction between the coils, it is necessary to increase the gap between the magnetic poles of the coils and to supply a large current to the coils.

When heating a head slider, it is possible to use a method where the head slider is disposed on a plate that favorably conducts heat and the plate is heated using a small ceramic heater or a heating wire. To evaluate the temperature characteristics of a magnetic head, it is necessary to correctly measure the temperature of the magnetic head. Although there is a method that measures the temperature of a head slider using a thermocouple, such method measures the average temperature of the surface of a head slider and does not express the temperature of a vicinity of the magnetic head. Also, as a method of measuring the temperature of the vicinity of the magnetic head, there is a method that supplies a current to the read element and measures changes in the resistance of the read element. However, since the resistance itself will change due to the magnetoresistance effect of the magnetic head when a measurement of ρH is carried out, there has been the problem that it is not possible to distinguish between changes due to temperature and changes due to magnetic fields.

The present invention was conceived to solve the problems described above and it is an object of the present invention to provide a characteristics evaluating method and a characteristics evaluating apparatus for a magnetic head that can accurately and easily evaluate the durability of a magnetic head to external magnetic fields and can efficiently evaluate the magnetic characteristics of a magnetic head.

To achieve the stated object, a characteristics evaluating method for a magnetic head according to the present invention includes: a step of disposing a head slider, which is supported on a rotating support mechanism, so that a direction of a magnetic field generated by a magnetic field generating apparatus matches a direction of a hard bias magnetic field of the head slider, and applying a static magnetic field onto the head slider using the magnetic field generating apparatus in a direction that is antiparallel to the hard bias magnetic field; and a step of disposing, after the static magnetic field has been applied to the head slider, the head slider so that a direction of an air-bearing surface is perpendicular to the magnetic field generated by the magnetic field generating apparatus, applying an alternating magnetic field to the head slider using the magnetic field generating apparatus, and carrying out measurement of ρH, wherein characteristics of the magnetic head are evaluated by repeating a process where the strength of the static magnetic field is increased in stages and measurement of ρH is carried out whenever the strength is increased.

FIGS. 1A to 1D show the principles of the characteristics evaluating method for a magnetic head according to the present invention.

FIG. 1A shows a state where a static magnetic field is being applied to an HGA (Head Gimbal Assembly) 10 where a head slider 12 has been mounted on a suspension 11. FIG. 1B shows a state where an alternating magnetic field is being applied to the air-bearing surface (ABS surface) of the head slider 12 and a ρH test is being carried out. According to the present invention, a single magnetic field generating apparatus 14 is used as the magnetic field generating apparatus 14 that applies a static magnetic field to the head slider 12 and the magnetic field generating apparatus 14 that applies an alternating magnetic field to the head slider 12, and tests are carried out by inverting the orientation of the head slider 12.

In FIG. 1A, the direction of the hard bias magnetic field of the magnetic head formed on the head slider 12 and the direction of the magnetic field generated by the magnetic field generating apparatus 14 are parallel and in FIG. 1B, the air-bearing surface of the head slider 12 and the direction of the magnetic field generated by the magnetic field generating apparatus 14 are perpendicular. Note that when a static magnetic field is applied onto the head slider 12 as an external magnetic field, the direction of the magnetic field is antiparallel to the hard bias magnetic field, that is, a direction that cancels out the hard bias magnetic field.

FIG. 1C shows an example pattern of a static magnetic field applied to the head slider 12 and FIG. 1D shows an example pattern of an alternating magnetic field.

Note that it is possible to carry out testing in a state where the head slider is assembled as an HGA and also possible to carry out testing on a single head slider before an HGA is assembled.

Also, in the characteristics evaluating method for a magnetic head according to the present invention, a product equipped with a DFH mechanism may be used as the head slider, and in the step of applying the static magnetic field and the step of carrying out the measurement of ρH, a current may be supplied to the DFH mechanism and measurement may be carried out while locally heating the head slider. By doing so, it is possible to carry out measurement while effectively heating the magnetic head.

A characteristics evaluating apparatus for a magnetic head includes: a magnetic field generating apparatus that generates a magnetic field to be applied to a head slider; a rotating support mechanism that rotates and supports the head slider between a position where the magnetic field generated by the magnetic field generating apparatus and a hard bias magnetic field of the head slider are antiparallel and a position where an air-bearing surface of the head slider is perpendicular to a direction of the magnetic field generated by the magnetic field generating apparatus; an external magnetic field applying unit for applying a static magnetic field to the head slider using the magnetic field generating apparatus at the position where the magnetic field generated by the magnetic field generating apparatus and the hard bias magnetic field of the head slider are antiparallel; and a unit for applying an alternating magnetic field onto the head slider using the magnetic field generating apparatus and carrying out measurement of ρH at the position where the air-bearing surface of the head slider is perpendicular to the direction of the magnetic field generated by the magnetic field generating apparatus.

The rotating support mechanism may include a rotating actuator that uses compressed air as a driving source. By doing so, it is easy to control the orientation of the head slider.

Also, by further including a unit for cooling the magnetic head by expelling cooling air onto the head slider supported by the rotating support mechanism, it is possible to test the characteristics of a magnetic head in a cooled state.

Also, when a product equipped with a DFH mechanism is used as the head slider, the characteristics evaluating apparatus may further include a DFH current source that supplies current to the DFH mechanism provided in the head slider to heat the magnetic head. By doing so, it is possible to efficiently heat a magnetic head and reliably measure the magnetic characteristics of a magnetic head at high temperature.

A characteristics evaluating apparatus for a magnetic head may further include: a unit for monitoring temperature in a vicinity of the magnetic head by supplying current to a write element of the head slider and detecting fluctuations in a resistance of the write element; and a control unit that uses a detection signal of the write element as a feedback signal and carries out control to keep the temperature in the vicinity of the magnetic head constant. By doing so, it is possible to accurately control and measure the temperature of the magnetic head.

According to the characteristics evaluating method and the characteristics evaluating apparatus according to the present invention, by supporting the head slider using a rotating support mechanism and changing the direction of the head slider with respect to a single magnetic field generating apparatus, it is easy to carry out an operation that applies a static magnetic field to the head slider as an external magnetic field and also applies an alternating magnetic field for carrying out ρH tests. By doing so, it is possible to efficiently and reliably evaluate the magnetic characteristics of a magnetic head under the influence of an external magnetic field.

### BRIEF DESCRIPTION OF THE DRAWINGS

FIGS. 1A to 1D are diagrams useful in explaining the principles of a characteristics evaluating method for a magnetic head;

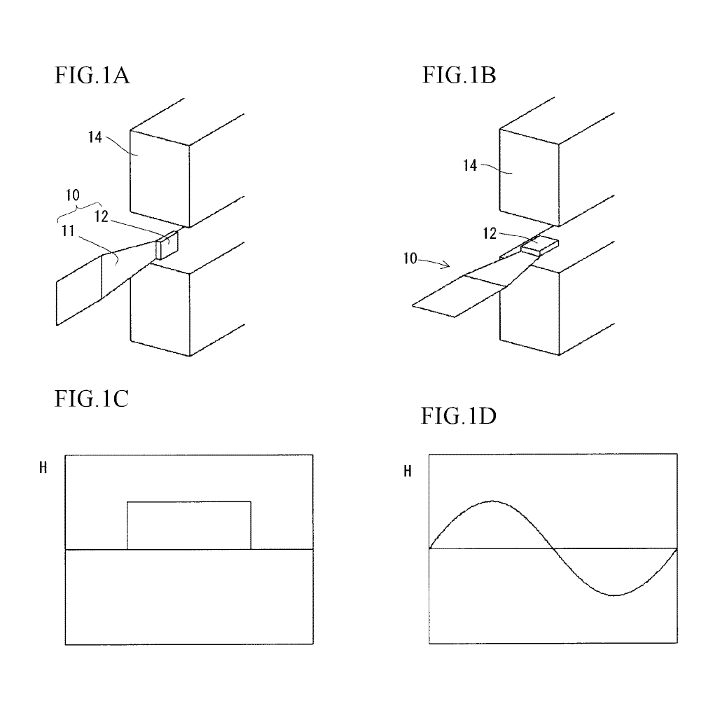

FIG. 2 is a block diagram showing the overall construction of a characteristics evaluating apparatus;

FIG. 3 is a perspective view of an example of a characteristics evaluating apparatus for a magnetic head;

FIGS. 4A and 4B are graphs showing the rate of change in magnetoresistance and output ratio for an external magnetic field;

FIGS. 5A and 5B are graphs showing example measurements of ρH curves; and

FIG. 6 is a block diagram showing an example of an apparatus for applying a magnetic field to a test element and testing the characteristics of the test element.

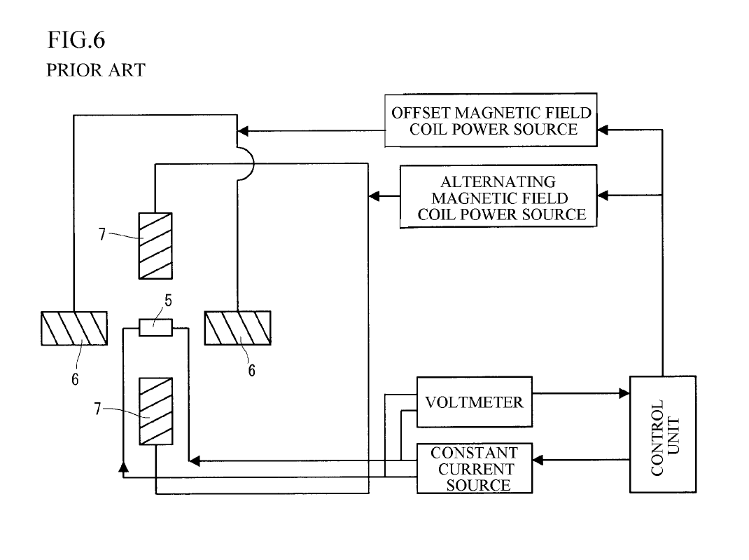

### DESCRIPTION OF THE PREFERRED EMBODIMENTS

### Characteristics Evaluating Apparatus for a Magnetic Head

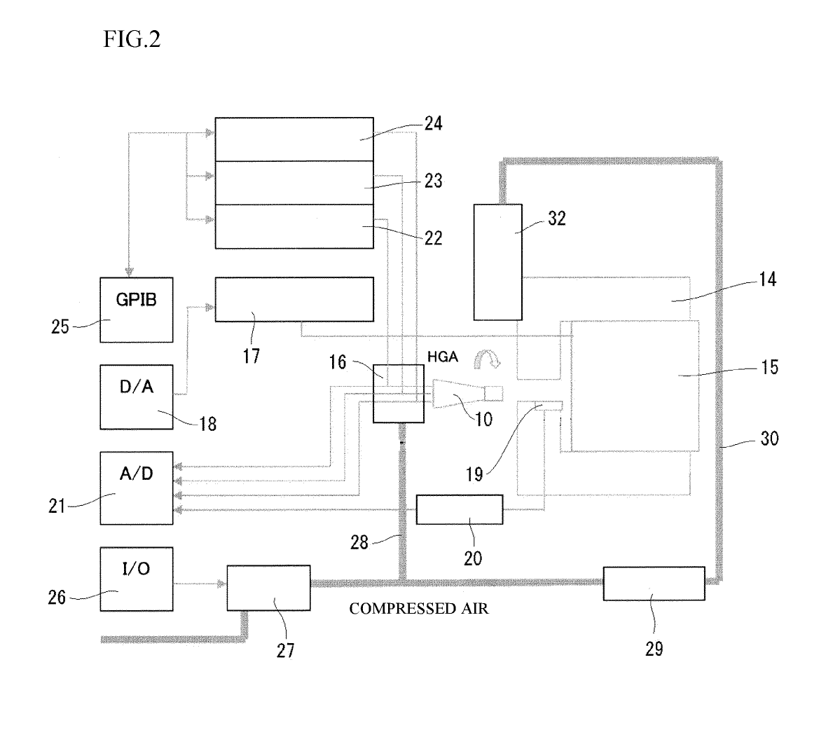

FIG. 2 is a block diagram showing the overall construction of a characteristics evaluating apparatus that evaluates the characteristics of a magnetic head. The characteristics evaluating apparatus according to the present embodiment is an apparatus for testing the HGA 10 on which a head slider has been mounted, and includes a magnetic field generating apparatus 14 and a rotary actuator 16 as a rotating support mechanism of a head slider that supports the HGA 10.

A coil 15 of the magnetic field generating apparatus 14 is connected to a coil bipolar power supply 17 and the coil bipolar power supply 17 is connected to a D/A converter 18. The coil bipolar power supply 17 is controlled by the D/A converter 18 to supply an arbitrary current to the coil 15, thereby causing the magnetic field generating apparatus 14 to generate a magnetic field (a static magnetic field or alternating magnetic field) of an arbitrary strength. The strength of the magnetic field between the magnetic poles of the magnetic field generating apparatus 14 is detected by a Hall element 19 attached to one of the magnetic poles. The Hall element 19 is connected to a Gaussmeter 20 and the output of the Gaussmeter 20 is detected by an A/D converter 21.

A read element constant power supply 22, a write element constant power supply 23, and a DFH current source 24 are electrically connected to the read element, the write element, and the DFH mechanism of the magnetic head, respectively. A support jig that supports the HGA 10 is provided on the rotary actuator 16. The read element, the write element, and the DFH mechanism of the head slider mounted on the HGA 10 are respectively electrically connected to the power supplies mentioned above by attaching the HGA 10 to the support jig.

A DFH (Dynamic Flying Height) mechanism is a mechanism for controlling the flying height of a magnetic head above a medium surface. This is achieved by incorporating a heater in the head slider and controlling thermal expansion of the head slider (i.e., protrusion of the magnetic head toward the medium) by controlling the supplying of current to the heater.

The rotary actuator 16 supports the HGA 10 so that the orientation of the head slider mounted on the HGA 10 can be rotated between an orientation where the air-bearing surface becomes parallel to a magnetic field and an orientation where the air-bearing surface becomes perpendicular to the magnetic field. According to the present embodiment, a construction is used where a compressed air source and the rotary actuator 16 are connected by a pipe 28, a solenoid valve 27 is provided on the pipe 28, and the rotary actuator 16 is driven by compressed air. Opening and closing of the solenoid valve 27 are controlled by an I/O controller 26.

The compressed air source is also connected via the solenoid valve 27, a dry filter 29, and a pipe 30 to a cooling gas generator 32. In the present embodiment, a product that uses a vortex effect is used as the cooling gas generator 32. For this cooling gas generator 32, the minimum temperature reached by the cooling gas changes according to the pressure and the flow rate of the compressed air flowing inside the pipe. This means that by controlling the pressure and/or flow rate of the compressed air, it is possible to adjust the temperature of the cooling gas.

The cooling gas generator 32 is disposed so as to emit the cooling gas toward the head slider of the HGA 10 that is supported by the rotary actuator 16. The dry filter 29 is provided so that dried air is emitted toward the head slider.

### Operation of the Characteristics Evaluating Apparatus

The method of evaluating the characteristics of a magnetic head using the characteristics evaluating apparatus described above will now be described.

The durability of a magnetic head to external magnetic fields is evaluated as follows.

First, the HGA 10 is placed between the magnetic poles of the magnetic field generating apparatus 14 and the rotary actuator 16 is driven to rotate the HGA 10 about the axis of the HGA 10 so that the orientation of the air-bearing surface of the head slider mounted on the HGA 10 becomes parallel to the magnetic field generated by the magnetic field generating apparatus 14. When the head slider is in this orientation, the hard bias magnetic field of the head slider becomes parallel to the magnetic field generated by the magnetic field generating apparatus 14.

Next, an external signal is inputted into the coil bipolar power supply 17 from the D/A converter 18 so that a static magnetic field is applied to the head slider mounted on the HGA 10. This static magnetic field is orientated so as to cancel out the hard bias magnetic field (i.e., is antiparallel to the hard bias magnetic field).

To monitor the magnetic field strength that is actually generated from the magnetic field generating apparatus 14, the analog output of the Hall element 19 is inputted into the A/D converter 21 via the Gaussmeter 20 whose voltage has been calibrated in advance. To minimize the difference between the strength of the magnetic field obtained by the A/D converter 21 and the strength of the desired magnetic field to be applied to the magnetic head, an external signal is inputted into the coil bipolar power supply 17 while feeding back the output of the Hall element 19. When doing so, to prevent the magnetic field strength that is actually generated from overshooting the desired magnetic field strength, the external signal inputted into the coil bipolar power supply 17 is accurately controlled.

After the static magnetic field has been applied to the head slider, the rotary actuator 16 is caused to rotate to make the orientation of the air-bearing surface of the head slider perpendicular to the direction of the magnetic field generated by the magnetic field generating apparatus 14. After this, measurements of ρH are carried out while applying an alternating magnetic field to the head slider.

To generate an alternating magnetic field using the magnetic field generating apparatus 14, the external signal inputted into the coil bipolar power supply 17 is subjected to wave shaping so as to become a triangular wave, a sine wave, or a similar alternating wave. Since the resistance of the read element of the magnetic head will change in accordance with the alternating magnetic field, by controlling the read element constant power supply 22 using a GPIB (General Purpose Interface Bus) 25 so that a constant current flows to the read element, it is possible to detect the changes in the resistance of the read element as changes in voltage.

By sampling the electric signal produced by converting the resistance of the read element to a voltage and the alternating magnetic field strength at such time at high speed using the A/D converter 21, it is possible to obtain the momentary magnetoresistance (ρ) for an arbitrary magnetic field strength (H), and thereby obtain a ρH curve. According to this measurement method, even if hysteresis occurs due to the alternating magnetic field, this will have no effect on the measurement itself.

By repeating an operation where the strength of the static magnetic field applied to the head slider is increased in stages and measurement of ρH is carried out while applying the static magnetic field, it is possible to obtain transitions in the magnetic characteristics of the magnetic head in response to a static magnetic field (external magnetic field). By merely looking at such transitions in the magnetic characteristics of the magnetic head, it is possible to evaluate the durability of the magnetic head to external magnetic fields.

The characteristics of the magnetic head with respect to temperature are evaluated as described below.

The magnetic head is cooled by emitting cooling gas, which has been ejected from the cooling gas generator 32, onto the head slider. Here, it is possible to carry out temperature control by measuring the temperature of the magnetic head while emitting the cooling gas from the cooling gas generator 32 onto the head slider and feeding back the measurement result.

The magnetic head is heated by supplying a current to the DFH mechanism (DFH coil) formed on the head slider. That is, the amount of current supplied from the DFH current source 24 to the DFH coil is controlled to adjust the heating temperature. Since the DFH coil is designed so as to achieve an accurate rise in temperature according to the applied current, it is possible to accurately control the temperature in the vicinity of the magnetic head by controlling the current.

In the same way as during cooling, if it is possible to directly measure the temperature of the magnetic head during heating also, by feeding back such measurement result, it will be possible to control the temperature more accurately.

Normally, when the temperature changes, the resistance of a conductor will also change. A change in temperature can therefore be found using a temperature coefficient that is intrinsic to each material and the actual change in resistance. In the present embodiment, by monitoring the temperature of the magnetic head using changes in resistance that occur due to the temperature of the write element and feeding back the monitoring result, it is possible to carry out measurement in a state where the magnetic head is kept at a constant temperature.

To make it possible to detect the temperature of the write element, first, a current is supplied to the write element that is at room temperature using the write element constant power supply 23 that is connected to the write element. When doing so, to reduce the increase in temperature of the write element itself, a minute current of 1 mA or below is applied. After this, the resistance is calculated from the source current and the potential difference generated across both ends of the write element due to the current.

Next, by using the cooling method or heating method described above, the head slider is cooled or heated and the resistance at the same conditions as the room temperature environment is calculated. From the room temperature environment, the change in the resistance in the cooled or heated state, and the temperature coefficient of the write resistance, it is possible to calculate the change in temperature of the magnetic head.

That is, by detecting the resistance (i.e., voltage) of the write element while supplying a constant current to the write element using the write element constant power supply 23, it is possible to monitor the temperature of the magnetic head. By setting a detection signal (voltage signal) using the write element as a feedback signal, it is possible to carry out measurements of ρH in a state where the magnetoresistance effect head is kept at an arbitrary temperature.

A method that uses changes in resistance caused by the temperature of the write element has an advantage in that it is possible to accurately monitor the temperature in the vicinity of the magnetic head. There is also an advantage in that by using the resistance of the write element, the read element has no particular effect on the ρH characteristics.

According to the method described above, since it is possible to accurately control the magnetic head at a predetermined temperature, by changing the temperature in small stages by cooling or heating the head slider and carrying out measurements of ρH at each temperature, it is possible to evaluate changes in the magnetic characteristics of the magnetic head due to temperature.

By carrying out measurements of ρH in a state where the magnetoresistance effect head is kept at a low temperature or a high temperature, it is possible to evaluate the characteristics of the magnetic head at low temperature or high temperature.

### Example Construction of a Characteristics Evaluating Apparatus

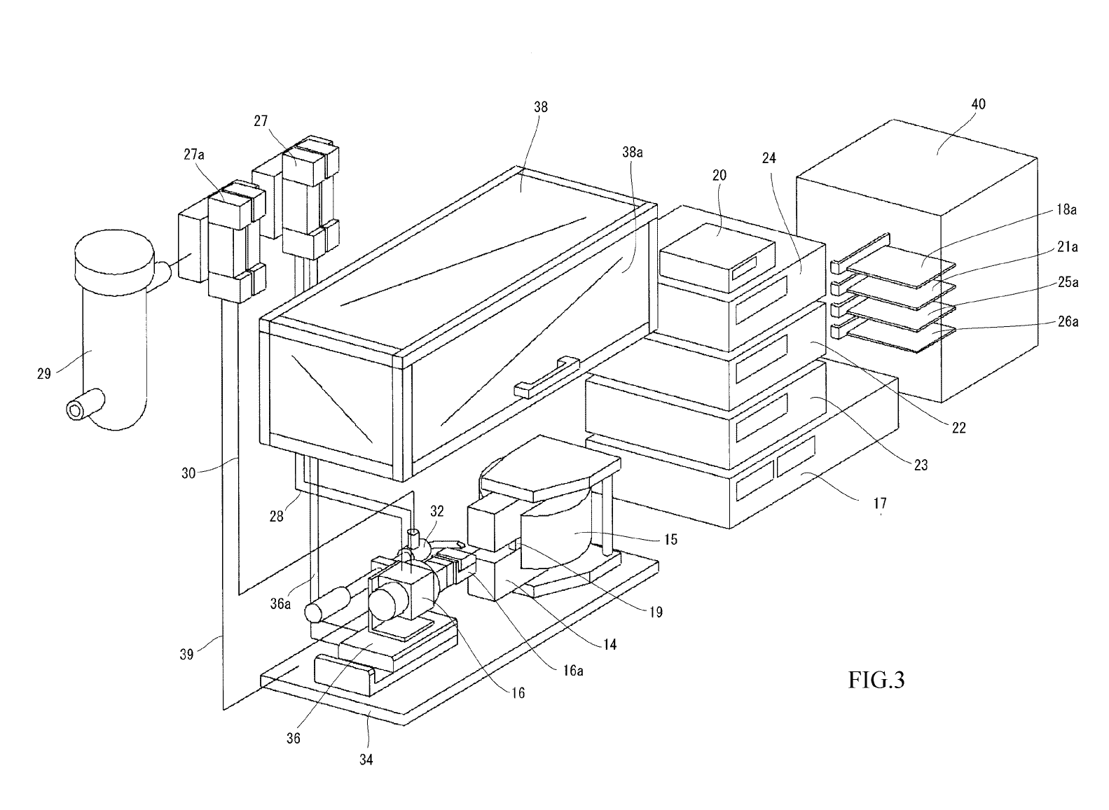

FIG. 3 shows an example of the actual construction of a characteristics evaluating apparatus for a magnetic head.

The magnetic field generating apparatus 14 and the rotary actuator 16 are disposed facing one another on a support stage 34. The rotary actuator 16 is supported on the support stage 34 via an air table 36 that moves forward and backward in a direction opposite the magnetic field generating apparatus 14. The air table 36 is connected via a pipe 36a and the solenoid valve 27 to a compressed air source and the driving direction thereof is switched by the solenoid valve 27 so that the air table 36 moves forward and backward. The rotary actuator 16 is also connected via the pipe 28 to the solenoid valve 27 and the driving direction thereof is switched by the solenoid valve 27.

A support jig 16a that detachably supports the HGA 10 is attached to a front portion of the rotary actuator 16. The support jig 16a includes a goniostage on one axis of a biaxial X-Y stage. By using this support jig 16a, the head slider mounted on the HGA 10 is positioned in the center of rotation of the rotary actuator 16 and can therefore be positioned so that the static magnetic field (offset magnetic field) is accurately applied in a direction that cancels out the hard bias magnetic field.

The cooling gas generator 32 is disposed alongside the rotary actuator 16. The cooling gas outlet of the cooling gas generator 32 is disposed so as to face the head slider mounted on the HGA 10.

Side surfaces and upper surfaces of the magnetic field generating apparatus 14, the rotary actuator 16, the air table 36, and the cooling gas generator 32 disposed on the support stage 34 are surrounded by a case 38 so as to be shielded from the outside during normal use. In FIG. 3, for ease of understanding, a state where the case 38 has been lifted above the support stage 34 is shown. An opening/closing door 38a on which a handle is provided is formed in a side surface of the case 38. When the HGA 10 that is the tested product is replaced, the opening/closing door 38a is opened and the product is replaced.

The compressed air source is connected via the dry filter 29, the solenoid valve 27a, and a pipe 39 to the inside of the case 38.

Due to the case 38, the space in which the magnetic field generating apparatus 14, the rotary actuator 16, and the like are disposed is a sealed space that is shielded from the outside, and therefore the humidity inside the case 38 can be stabilized and condensation on the head and parts of the apparatus itself can be prevented during cooling.

The various power sources such as the read element constant power supply 22 are disposed to the side of the support stage 34. In the host computer 40, a D/A board 18a, an A/D board 21a, a GPIB board 25a, and a digital I/O board 26a are disposed to control the D/A converter 18, the A/D converter 21, the GPIB 25, and the I/O controller 26, respectively.

On/off control of the solenoid valves 27, 27a is carried out by the digital I/O board 26a. The digital I/O board 26a operates according to commands from the host computer 40.

The read element constant power supply 22, the write element constant power supply 23, and the DFH current source 24 also operate according to commands from the host computer 40 received via the GPIB 25.

Each power supply is controlled via the driving current thereof, and the potentials at both ends of the elements such as the read element are obtained via the A/D board 21a.

### Characteristics Evaluating Method

A procedure for evaluating the characteristics of a magnetic head using the characteristics evaluating apparatus according to the embodiment described above will now be described.

Step 1: The opening/closing door 38a is opened and an HGA is set on the support jig 16a attached to the rotary actuator 16.
Step 2: In a state where no magnetic field is applied, a current is supplied from the read element constant power supply 22 until there is a predetermined voltage across both ends of the read element. The voltage of the read element is obtained by the A/D converter 21 and the resistance of the read element is calculated. If the calculated resistance is not within a stipulated range, the element is judged to be defective and measurement is terminated.
Step 3: When the resistance of the read element is within a predetermined range, the air table 36 is moved forward toward the magnetic field generating apparatus 14 and the head slider mounted on the HGA 10 is inserted between the magnetic poles of the magnetic field generating apparatus 14.
Step 4: The rotary actuator 16 is caused to rotate the HGA 10 so that the air-bearing surface of the head slider becomes parallel to the direction of the magnetic field generated by the magnetic field generating apparatus 14.
Step 5: A remote signal is inputted from the D/A converter 18 into the coil bipolar power supply 17 according to a command from the host computer 40 so that a static magnetic field is generated from the coil 15. The generated magnetic field is detected by the Hall element 19 and is obtained by the A/D converter 21 via the Gaussmeter 20. The remote signal is adjusted so that the output of the Gaussmeter 20 obtained by the A/D converter 21 becomes a predetermined value. After the magnetic field strength achieved by the magnetic field generating apparatus 14 has reached a predetermined value, the static magnetic field is applied to the head slider until a time period that is decided in advance has elapsed. The direction of the static magnetic field is a direction that cancels out the hard bias magnetic field of the head slider.
Step 6: After the static magnetic field has been applied, the supplying of current to the coil 15 is stopped by a remote signal, and the rotary actuator 16 is caused to rotate the HGA 10 so that the air-bearing surface of the head slider becomes perpendicular to the direction of the magnetic field generated by the magnetic field generating apparatus 14.
Step 7: According to a command from the host computer 40, a triangular remote signal is inputted from the D/A converter 18 into the coil bipolar power supply 17 so that an alternating magnetic field is generated from the coil 15. According to a command from the host computer 40, the voltage across both ends of the read element is sampled via the A/D converter 21 and a signal from the Hall element 19 is simultaneously sampled via the Gaussmeter 20 to obtain ρH data for one cycle in the remote signal.
Step 8: Data on the resistance, amplitude, symmetry, and the like is calculated from the obtained ρH data.

After this, when one measurement has been completed, the operations in Step 4 to Step 8 are repeated while gradually increasing the strength of the magnetic field generated from the coil 15 in Step 5. By doing so, it is possible to examine how the ρH curve changes in accordance with the static magnetic field applied to the head slider.

Measurement of ρH is carried out for the magnetic head as follows when the head slider mounted on the HGA 10 is cooled.

When the procedure in Step 4 has been completed, the OUT port of the solenoid valve 27a is opened and dried air is introduced into the case 38. A dew point meter (not shown) is installed inside the case 38 and a sensor of the dew point meter operates when the inside of the case 38 has been dried to a predetermined dew point. The operation signal of the sensor is monitored by the digital I/O board 26a and is supplied to the host computer 40 as an interrupt signal. The host computer 40 stops the introduction of dried gas when the dew point inside the case 38 has fallen.

The host computer 40 sends an instruction via the GPIB 25 to the write element constant power supply 23 to have a set constant current supplied to the write element. The voltage across both ends of the write element is obtained by the A/D converter 21 and the resistance of the write element is calculated from the voltage at that time. In addition, the ambient temperature inside the case 38 at this time is obtained as the reference temperature.

Next, the OUT port of the solenoid valve 27a is opened and dried air is introduced into the cooling gas generator 32. The cooling air emitted from the cooling gas generator 32 is expelled toward the head slider mounted on the HGA 10 to lower the surface temperature of the head slider. Changes in the resistance of the write element that accompany this drop in temperature are obtained by the A/D converter 21 and the resistance of the write element is calculated from the voltage at this time.

From the resistance of the write element at the reference temperature described above and the resistance of the write element during cooling, the drop in temperature from the reference temperature is calculated. While monitoring the resistance so as to keep the temperature of the write element at a predetermined value, the pressure and flow rate of the compressed air that flows to the cooling gas generator 32 are adjusted.

When the temperature has become constant, the procedure in step 5 described above onwards is carried out to obtain the ρH data. According to this method, in a state where the temperature of the head slider is controlled to become a low temperature, it is possible to carry out evaluation on measurements of ρH with respect to an external magnetic field.

It should be obvious that it is possible to carry out measurement of ρH in a low temperature environment by changing only the environmental temperature and applying an alternating magnetic field without applying an external magnetic field.

Measurement of ρH is carried out for a magnetoresistance effect head as follows when the head slider mounted on the HGA 10 is heated.

When the procedure in Step 4 described above has been completed, the host computer 40 sends an instruction from the GPIB 25 to the write element constant power supply 23 to cause a set constant current to flow to the write element of the magnetoresistance effect element. The voltage produced across both ends of the write element is obtained by the A/D converter 21 and the resistance of the write element is calculated from the voltage at that time. In addition, the ambient temperature inside the case 38 at this time is obtained as the reference temperature.

Next, an instruction is sent from the GPIB 25 to the DFH current source 24 to cause a current to flow to the DFH coil of the head slider. As a result, the DFH coil heats up, thereby causing the temperature of the write element to rise.

The change in the resistance of the write element that accompanies this rise in temperature is obtained by the A/D converter 21 and the resistance of the write element is calculated from the voltage at this time.

From the resistance of the write element at the reference temperature and the resistance of the write element during heating, the temperature rise from the reference temperature is calculated. While monitoring the resistance so as to keep the temperature of the write element at a predetermined value, the current that flows to the DFH coil is adjusted.

When the temperature has become constant, the procedure in step 5 described above onwards is carried out. According to this method, in a state where the temperature of the head slider is controlled to become a high temperature, it is possible to evaluate measurements of ρH for a static magnetic field (i.e., an external magnetic field).

It should be obvious that it is possible to carry out measurement of ρH in a high temperature environment by changing only the environmental temperature and applying an alternating magnetic field without applying an external magnetic field.

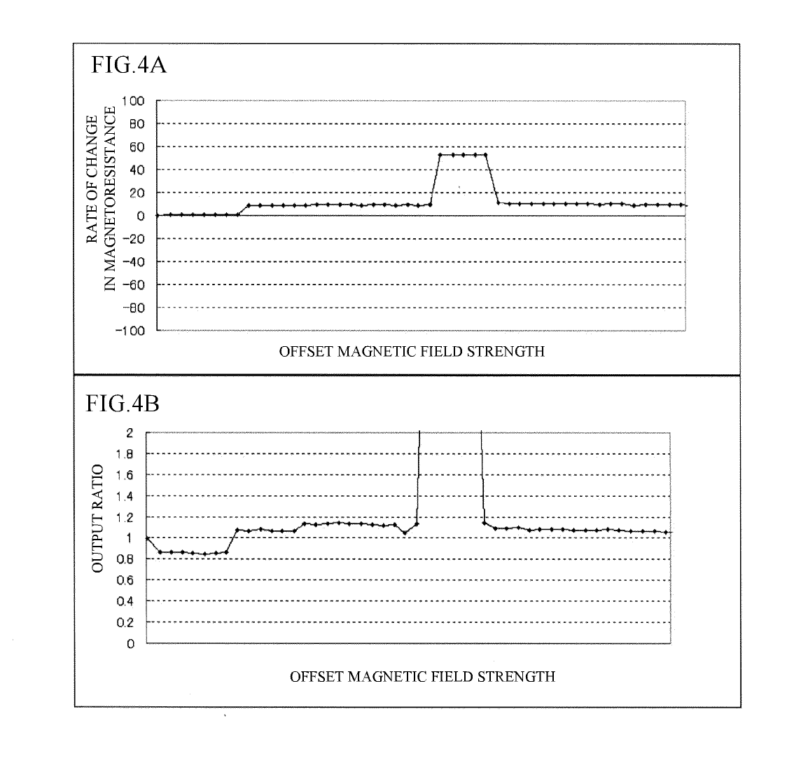

FIG. 4A and FIG. 4B show examples of the rate of change in magnetoresistance and output ratio for an external magnetic field obtained using the apparatus described above. The horizontal axis shows the external magnetic field (static magnetic field) that is applied. The results are shown for a case where measurements are taken while gradually increasing the external magnetic field from a state where the external magnetic field is zero.

Here, it can be understood that when the external magnetic field is weak, the change in the magnetic characteristics of the magnetoresistance effect head is small, but as the external magnetic field is increased, there is a point where the characteristics suddenly change.

That is, from the points in the graphs, it is possible to evaluate the durability of a magnetoresistance effect head to external magnetic fields.

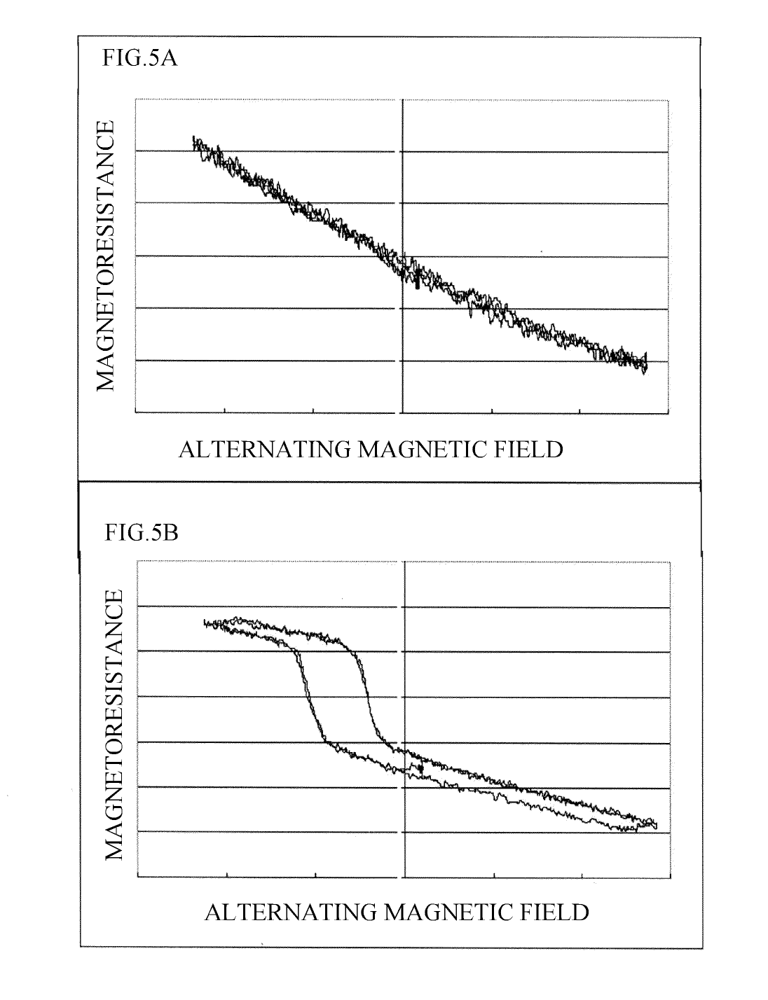

FIGS. 5A and 5B show ρH curves that were actually obtained by applying an alternating magnetic field to a head slider. FIG. 5A is a ρH curve for a case were the external magnetic field applied to the head slider is small and FIG. 5B is a ρH curve for a case were the external magnetic field applied to the head slider is large. Although the ρH curve exhibits favorable linearity when the external magnetic field applied to the head slider is weak, as the external magnetic field increases, the ρH curve greatly deviates from a straight line. This shows that when a large external magnetic field acts upon the head slider, the magnetoresistance effect head loses its original characteristics.

In this way, by measuring the ρH curve while changing the external magnetic field in stages or by measuring the ρH curve while changing the environmental temperature of the head slider, it is possible to know the durability of a magnetoresistance effect head to external magnetic fields and to know how the characteristics change due to temperature.

In particular, with the characteristics evaluating apparatus according to the present invention, it is possible to accurately apply an external magnetic field (i.e., a static magnetic field) onto a head slider and to accurately apply an alternating magnetic field and carry out ρH tests. By rotating the head slider using a rotary actuator, it is possible to easily and accurately apply an alternating magnetic field to the head slider, so that tests can be carried out efficiently and a large reduction can be made in the time taken by testing.

What is claimed is:

1. A characteristics evaluating method for a magnetic head, comprising:
a step of disposing a head slider, which is supported on a rotating support mechanism, so that a direction of a magnetic field generated by a magnetic field generating apparatus matches a direction of a hard bias magnetic field of the head slider, and applying a static magnetic field onto the head slider using the magnetic field generating apparatus in a direction that is antiparallel to the hard bias magnetic field; and
a step of disposing, after the static magnetic field has been applied to the head slider, the head slider so that a direction of an air-bearing surface is perpendicular to the magnetic field generated by the magnetic field generating apparatus, applying an alternating magnetic field to the head slider using the magnetic field generating apparatus, and carrying out measurement of ρH,
wherein characteristics of the magnetic head are evaluated by repeating a process where the strength of the static magnetic field is increased in stages and measurement of ρH is carried out whenever the strength is increased.

2. A characteristics evaluating method for a magnetic head according to claim 1,
wherein a product equipped with a DFH mechanism is used as the head slider,
and in the step of applying the static magnetic field and the step of carrying out the measurement of ρH, a current is supplied to the DFH mechanism and measurement is carried out while locally heating the head slider.

3. A characteristics evaluating apparatus for a magnetic head comprising:
a magnetic field generating apparatus that generates a magnetic field to be applied to a head slider;
a rotating support mechanism that rotates and supports the head slider between a position where the magnetic field generated by the magnetic field generating apparatus and a hard bias magnetic field of the head slider are antiparallel and a position where an air-bearing surface of the head slider is perpendicular to a direction of the magnetic field generated by the magnetic field generating apparatus;
external magnetic field applying means for applying a static magnetic field to the head slider using the magnetic field generating apparatus at the position where the magnetic field generated by the magnetic field generating apparatus and the hard bias magnetic field of the head slider are antiparallel; and
means for applying an alternating magnetic field onto the head slider using the magnetic field generating apparatus and carrying out measurement of ρH at the position where the air-bearing surface of the head slider is perpendicular to the direction of the magnetic field generated by the magnetic field generating apparatus.

4. A characteristics evaluating apparatus for a magnetic head according to claim 3,
wherein the rotating support mechanism includes a rotating actuator that uses compressed air as a driving source.

5. A characteristics evaluating apparatus for a magnetic head according to claim 3,
further comprising means for cooling the magnetic head by expelling cooling air onto the head slider supported by the rotating support mechanism.

6. A characteristics evaluating apparatus for a magnetic head according to claim 4,
further comprising means for cooling the magnetic head by expelling cooling air onto the head slider supported by the rotating support mechanism.

7. A characteristics evaluating apparatus for a magnetic head according to claim 3,
wherein a product equipped with a DFH mechanism is used as the head slider, and
the characteristics evaluating apparatus further comprises a DFH current source that supplies current to the DFH mechanism provided in the head slider to heat the magnetic head.

8. A characteristics evaluating apparatus for a magnetic head according to claim 4,
wherein a product equipped with a DFH mechanism is used as the head slider, and
the characteristics evaluating apparatus further comprises a DFH current source that supplies current to the DFH mechanism provided in the head slider to heat the magnetic head.

9. A characteristics evaluating apparatus for a magnetic head according to claim 5,
wherein a product equipped with a DFH mechanism is used as the head slider, and
the characteristics evaluating apparatus further comprises a DFH current source that supplies current to the DFH mechanism provided in the head slider to heat the magnetic head.

10. A characteristics evaluating apparatus for a magnetic head according to claim 6,
wherein a product equipped with a DFH mechanism is used as the head slider, and
the characteristics evaluating apparatus further comprises a DFH current source that supplies current to the DFH mechanism provided in the head slider to heat the magnetic head.

11. A characteristics evaluating apparatus for a magnetic head according to claim 3, further comprising:
means for monitoring temperature in a vicinity of the magnetic head by supplying current to a write element of the head slider and detecting fluctuations in a resistance of the write element; and
a control unit that uses a detection signal of the write element as a feedback signal and carries out control to keep the temperature in the vicinity of the magnetic head constant.

12. A characteristics evaluating apparatus for a magnetic head according to claim 4, further comprising:
means for monitoring temperature in a vicinity of the magnetic head by supplying current to a write element of the head slider and detecting fluctuations in a resistance of the write element; and
a control unit that uses a detection signal of the write element as a feedback signal and carries out control to keep the temperature in the vicinity of the magnetic head constant.

13. A characteristics evaluating apparatus for a magnetic head according to claim 5, further comprising:
means for monitoring temperature in a vicinity of the magnetic head by supplying current to a write element of the head slider and detecting fluctuations in a resistance of the write element; and
a control unit that uses a detection signal of the write element as a feedback signal and carries out control to keep the temperature in the vicinity of the magnetic head constant.

14. A characteristics evaluating apparatus for a magnetic head according to claim 6, further comprising:
means for monitoring temperature in a vicinity of the magnetic head by supplying current to a write element of the head slider and detecting fluctuations in a resistance of the write element; and
a control unit that uses a detection signal of the write element as a feedback signal and carries out control to keep the temperature in the vicinity of the magnetic head constant.

15. A characteristics evaluating apparatus for a magnetic head according to claim 7, further comprising:
means for monitoring temperature in a vicinity of the magnetic head by supplying current to a write element of the head slider and detecting fluctuations in a resistance of the write element; and
a control unit that uses a detection signal of the write element as a feedback signal and carries out control to keep the temperature in the vicinity of the magnetic head constant.

16. A characteristics evaluating apparatus for a magnetic head according to claim 8, further comprising:
means for monitoring temperature in a vicinity of the magnetic head by supplying current to a write element of the head slider and detecting fluctuations in a resistance of the write element; and
a control unit that uses a detection signal of the write element as a feedback signal and carries out control to keep the temperature in the vicinity of the magnetic head constant.

17. A characteristics evaluating apparatus for a magnetic head according to claim 9, further comprising:
means for monitoring temperature in a vicinity of the magnetic head by supplying current to a write element of the head slider and detecting fluctuations in a resistance of the write element; and
a control unit that uses a detection signal of the write element as a feedback signal and carries out control to keep the temperature in the vicinity of the magnetic head constant.

18. A characteristics evaluating apparatus for a magnetic head according to claim 10, further comprising:
means for monitoring temperature in a vicinity of the magnetic head by supplying current to a write element of the head slider and detecting fluctuations in a resistance of the write element; and
a control unit that uses a detection signal of the write element as a feedback signal and carries out control to keep the temperature in the vicinity of the magnetic head constant.
